(19) United States
(12) Patent Application Publication
(10) Pub. No.: US 2026/0278486 A1
(43) Pub. Date: Sep. 17, 2026

(54) Transaction processing system with efficient data handling

(71) Applicant: ALG Vacations Corp., Milwaukee, WI (US)

(72) Inventors: Thomas Michael Lowery, II, Richardson, TX (US); Kedarnath Benegal, Colleyville, TX (US)

(21) Appl. No.: 19/445,990

(22) Filed: Jan. 12, 2026

Related U.S. Application Data
(60) Provisional application No. 63/744,821, filed on Jan. 13, 2025.

(51) Int. Cl. G06Q 10/02; G06F 3/04842; G06F 21/62; G06Q 50/14

(52) U.S. Cl. CPC G06Q 10/02; G06F 3/04842; G06F 21/6245; G06Q 50/14

(57) ABSTRACT

A transaction processing method and system provides travel planning and booking workflows, typically in the form of curation, display and automated transacting of travel packages. Users interact with the service at least in part leveraging Al chat-based functions, and the system is configured and implemented to support very large numbers of concurrent search and retrieval operations in a highly-scalable, highly-available and highly-reliable performant manner. In one embodiment, a virtual search paradigms. One such paradigm enables users to shop in a distinct manner, sometimes referred to herein as a “destination-less search.”

### BACKGROUND

Individual airlines, hotels, automobile rental companies, and other travel-related service providers often maintain their own web sites providing retail sales. Many with complex offerings include search engine technology to look for bookings within a certain timeframe, service class, geographic location, or price range. For example, and from one or more branded or white-labeled sites, an online service provider may sell hotel packages (e.g., air+hotel) enabled by a search widget that requires an input of Origin, Destination, Departure Date, Return Date, and Number of Passengers. While this type of solution provides an end user with useful results from which to choose a package to purchase, the nature and number of results returned by this type of search are necessarily limited by the required search constraints.

### SUMMARY

A transaction processing system provides travel planning and booking workflows, typically in the form of curation, display and automated transacting of travel packages. Users interact with the service at least in part leveraging AI chat-based functions, and the system is configured and implemented to support very large numbers of concurrent search and retrieval operations in a highly-scalable, highly-available and highly-reliable performant manner.

In accordance with one example aspect, an Artificial Intelligence (AI) shopping-assistant architecture provides for a transaction processing system that leverages one or more search paradigms. One such paradigm enables users to shop in a distinct manner, sometimes referred to herein as a “destination-less search.” In this approach, an end user uses the search widget to view all options available out of a particular origin (typically an airport). Typically, the options span destinations, dates, and lengths of stay with respect to all property options presented. The user can then filter down based on any specific preferences (e.g., 5-star, all-inclusive, adults-only, price, etc.). As the user interacts with the system, an API checks user prompts for sensitive information, e.g., using AI language models. If no sensitive information is detected, the prompt is sent to an AI model, such as OpenAI. Based on the prompt, a predefined function is triggered to fetch and display relevant travel packages to the user.

To support the destination-less search paradigm (as well as other search paradigms exposed by the system), a distributed caching mechanism is provided to receive and store the raw data representing the options from one or more data sources. Given the large number of data sources and data types, theoretically there are a very large number of combinations of search widget results. To ensure that the cache is manageable to provide large number of transactions (searches) within the context of a highly available, reliable and scalable website infrastructure, preferably the data in the database is curated as collections of data against a particular key. In one embodiment, the key is based on a data triplet, such as [inventory, origin, number of nights of stay]. By curating the data using this format, the large number of combinations is sufficiently reduced to ensure a particular search is carried out with very low latency even as the number of concurrent transactions increases.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

For a more complete understanding of the subject matter and the advantages thereof, reference is now made to the following descriptions taken in conjunction with the accompanying drawings, in which:

FIG. 1 is a block diagram depicting an AI-supported transaction processing system according to an aspect of this disclosure;

FIGS. 2A-2B are a block diagram depicting further details of a frontend architecture of the system in one embodiment;

FIGS. 3A-3C depict additional details of a preferred price cache architecture of the system;

FIG. 4 depicts a write_vacations_to_blob pipeline of the price cache;

FIG. 5 depicts a conclusion_activities pipeline of the price cache; and

FIG. 6 depicts a query_push_activity pipeline of the price cache.

### DETAILED DESCRIPTION

In an exemplary (but non-limiting) embodiment, the operating domain in general is online retail travel site wherein an end user accesses a network-accessible application, e.g., a web app, a chat-based virtual travel assistant, or the like, to obtain information about available travel packages that are then available for reservation and purchase. In a representative embodiment, multiple such travel sites are serviced concurrently from a services platform, as will be described.

In a typical use case involving a network-accessible travel site (service), end users typically are consumers or persons/entities acting on their behalf and that interact with a transaction processing system (TPS) service using desktop computers, laptop computers, web-connected appliances, and mobile devices (smartphones and tablets). Preferably, an end user accesses the service using a computing device that comprises a CPU (central processing unit), computer memory, such as RAM, and a drive. The device software includes an operating system, and generic support applications and utilities. A computing device executes a browser, browser plug-in, or dedicated mobile app that renders web pages received from the service. Typically, the computing device connects to the server environment providing the “service” in a secure manner, e.g., via a TLS-secured connection, and must be authenticated (or otherwise authorized) into a collaboration session. Alternatively, or in addition to direct consumer interactions, interactions with the TPS service also are carried out programmatically, e.g., via an Application Programming Interface (API), or another request-response workflow.

The TPS “service” preferably is hosted in or in association with a cloud-based environment that comprises a set of services (or components). The service may be implemented using a set of computing resources that are co-located or themselves distributed. Typically, a service is implemented in one or more computing systems. The computing platform (or portions thereof) may be implemented in a dedicated environment, in an on-premises manner, as a cloud-based architecture, or some hybrid. A typical implementation of the compute infrastructure is in a cloud-computing environment. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (Saas) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). As previously noted, a compute infrastructure (a computing services platform) typically provides support for a set of branded travel sites.

Preferably, the above-described service leverages Artificial Intelligence (AI)/Machine Learning (ML) to support transaction workflows. An example but non-limiting transaction workflow involves curation, display and automated transacting of travel packages. Users interact with the service at least in part leveraging AI chat-based functions, and the system is configured and implemented to support very large numbers of concurrent search and retrieval operations in a highly-scalable, highly-available and highly-reliable performant manner. Users may be individuals seeking their own personal travel options, travel agents and others that provide travel assistance to individuals, groups or enterprises, and combinations thereof.

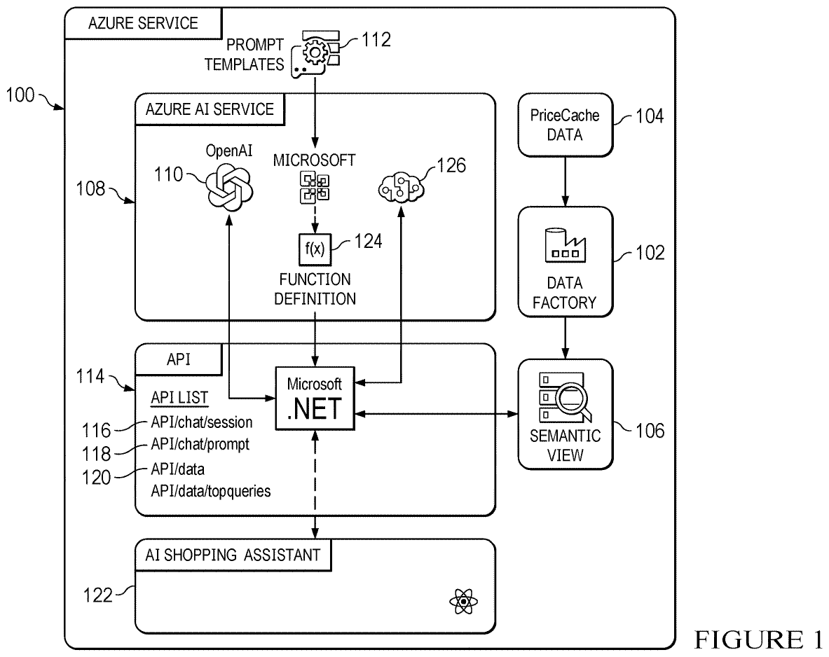

FIG. 1 depicts an Artificial Intelligence (AI) shopping-assistant architecture of an embodiment of this disclosure. In this embodiment, the architecture is integrated with and leverages an AI services component, such as Microsoft® Azure® AI Services. As will be described, the architecture utilizes data pipelines, semantic views, and Application Programming Interfaces (APIs) to deliver a seamless user shopping experience, e.g., with respect to search, curation, display and selection of personalized travel package. As used herein, a travel package typically comprises a combination of data elements, such as an origin location, a destination location, air travel to and from that origin to that destination, a hotel or resort identity and location, an associated time period, and perhaps one or more additional elements such as rental car, a resort amenity, resort activity data, and the like. Given this representative transaction space, and in this particular but non-limiting embodiment, the main components and interactions of the system are now described.

In this embodiment, preferably the architecture is implemented in a cloud compute infrastructure, such as an Azure® Service 100. As depicted and configured, the system comprises a data factory 102, which aggregates data from a price cache data source 104, and also prepares a consolidated semantic view 106 for processing by other components in the system. The data factory 102 may be implemented as an Azure Data Factory, which includes an SQL database and other related support. The price cache data source 104 is the primary data source for the system. As will be described in the workflows and in more detail below, the price cache supplies the pricing and availability information that are used to deliver a personalized shopping experience, e.g., for a travel package. Without intending to be limited, the price cache data store typically receives and stores various types of data from one or more external data sources, e.g., hotel prices (from RateGain®), flight prices (from Sabre®), hotel profile and related information (from ALG Vacations®), activity data (from Amstar®), weather data (from Azure Weather), and the like. The semantic view component 106 is a display output, typically implemented as one or more web pages, which provides a unified data table view. The components 102, 104, and 106 comprise an input data pipeline.

An AI service 108 comprises one or more AI models 110, one or more prompt templates 112, a set of custom logic (the function definition) 124, and an AI language service 126. The nature of the custom logic may vary depending on implementation, e.g., site-specific requirements; typically, the custom logic facilitates orchestration of the AI support layer, augments or enhances content (e.g., by providing recommendations and the like), and it also facilitates model training or re-training. The AI models 110 may be local, or they may be accessed as a remote service. An example set of one or more AI models 110 operated as a remote service is OpenAI, which also uses AI language services 126 for natural language understanding and response generation. In a representative embodiment, the AI language services 126 comprise a large language model (LLM). As noted, the custom logic 124 is configured to orchestrate data flow and AI model 110 interactions. Utilizing these components, the AI service 108 leverages the AI models for generating responses, and it integrates the prompt templates 112 for custom queries. The AI service 108 is also enabled by the semantic view 106, which organizes and provides data to the service 108 contextually. The above system components ensure accurate and contextually relevant responses by using the price cache data source 104 as a primary data source, by organizing data into semantic views 106, and by employing AI models 110 for natural language processing.

As also depicted in FIG. 1, the system architecture 100 also comprises one or more interfaces, typically APIs 114 supported in a backend, such as the Microsoft .NET-based backend. These APIs are reached as API endpoints including an API/chat/session endpoint 116 that handles chat sessions for user interactions, API/chat/prompt endpoint 118 that processes and forwards prompts to the AI model 110, and API/data endpoint 120 that serves data for semantic view or business logic. An AI shopping assistant 122 acts as a frontend to the APIs 114 in the backend. In one embodiment, the assistant is built in ReactJS. According to an aspect of this disclosure, the AI shopping assistant 122 is a web-based application or mobile device-based app that interfaces with the APIs 114 to enable end user interaction with the system to prompt for and obtain personalized shopping recommendations, e.g., customized travel packages.

The basic data flow of the system is as follows. The input data pipeline ingests data from the external sources, stores that data in the price cache data store, and that data is organized into a semantic view for seamless querying. The AI processing leverages the prompt templates to feed structured queries into the AI service, which includes or accesses AI models that process these prompts using the function definitions set out by the custom logic. The backend API facilitates interaction between the frontend (AI shopping assistant) and the backend service, and it handles data requests and dynamic queries to the system. The frontend provides for delivery of AI-generated responses to the AI shopping assistant, and it enhances user interaction through the web-based interface. The frontend also leverages the AI language service and (as necessary, custom content filtering mechanisms) to identify user prompt Personally Identifiable Information (PII), to block sensitive user prompts, and to create and deliver AI responses to prompts. In this manner, the AI service operates as a virtual travel assistant. More generally, the above-identified components provide for an AI-powered shopping assistant that leverages advanced AI services and seamless integration of data pipelines, APIs, and frontend interfaces to deliver a personalized and secure shopping experience. The function definitions, content filtering and tailored API endpoints enhance efficiency and reliability of the system, and the ReactJS-based interface further enriches user interaction. This architecture provides for a robust scalable, highly-available, highly-performant, and highly reliable solution for vacation booking and other travel-related shopping needs.

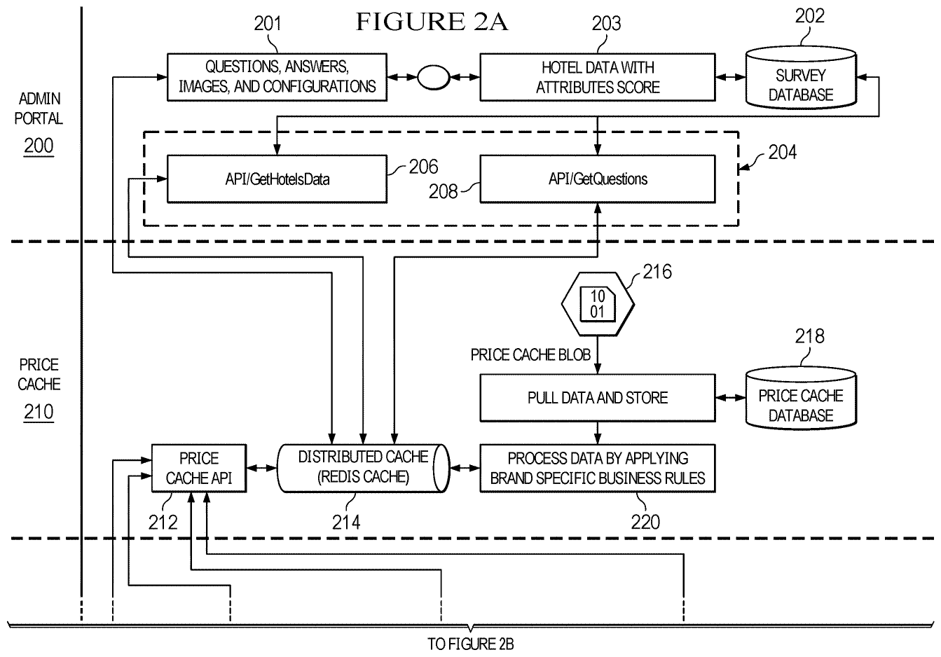

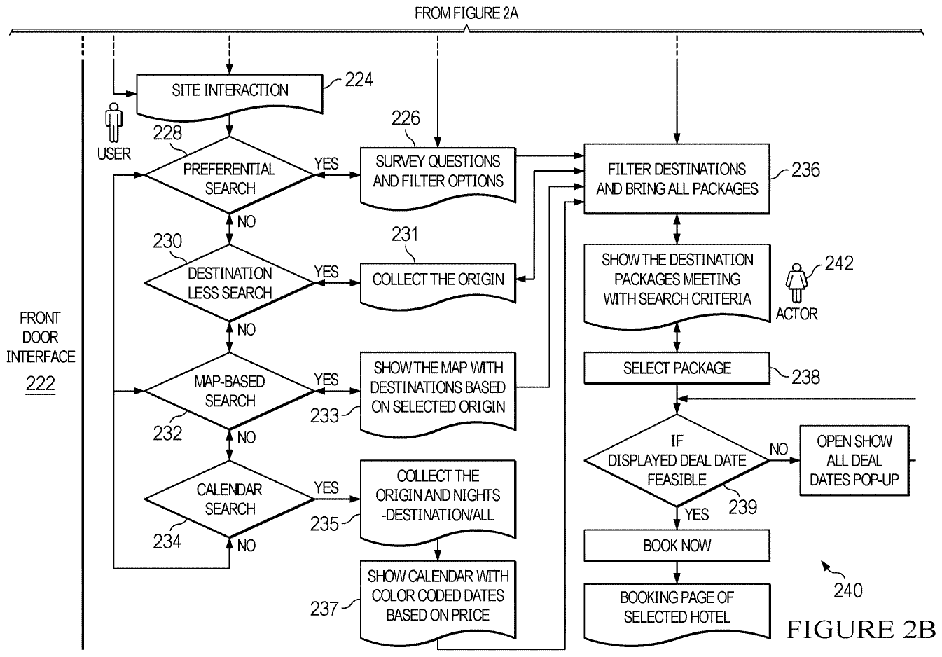

Referring now to FIGS. 2A-2B together, another view of the application architecture is provided, in this view with an emphasis on the user interactivity provided by a front door interface (FDI). The FDI corresponds to a portion of the frontend previously described. In this view, the components comprise an administrative portal 200, the price cache previously described 210, and the FDI functionality 222. The administrative portal 200 comprises a survey database 202 that stores survey questions, answers, configuration 201, and hotel data 203, preferably with attribute scores. The administrative portal 200 also provides several APIs 204, such as a GetHotelsData API 206 that is used to fetch hotel-related data, and a GetQuestions API 208 that is used to retrieve survey questions for user interaction.

The price cache 210 comprises a price cache API 212 that interfaces with a distributed cache 214 (e.g., implemented as a Redis in-memory data store) that enables high-speed retrieval of frequently accessed data. A price cache blob 216 processes and stores data, e.g., by applying brand-specific business rules including hotel details, flight availability, and pricing. A processing layer 220 applies brand-specific business rules to process pricing data, and a price cache database (DB) 218 maintains the processed pricing data for access by various other system components.

The front door interface (FDI) 222 provides for a main site interaction functionality 224 that supports multiple search modes including, without limitation, a survey questions and filter options mode 226 that captures user preferences with survey questions and filter options, a preferential search mode 228 that displays options based on user preferences collected in the survey, a destination-less search mode 230 that enables the user to perform searches without specifying a destination and, in particular, by merely collecting a specified origin 231, a map-based search mode 232 that displays destinations on a map based on selected origins 233, and a calendar search mode 234 that collects origin and number of nights data 235 and, at 237, shows a calendar with a color-coded data based on price. The site interaction functionality implements one or more of these modes to collect user inputs, such as origin, destination, number of nights, preferences, and the like. The FDI also provides for dynamic package filtering 236 that filters destinations and retrieves packages meeting user search criteria, package selection 238 that enables direct booking or viewing (e.g., via a pop-up) of all deals. As further depicted, step 239 determines if a displayed deal data is feasible and, if so, enables a booking workflow 240. The booking workflow 240 redirects users to booking pages or all-deal pop-ups for finalization. Stated another way, and through its booking pages, the booking workflow displays details of selected hotels (or other travel assets) and redirects users (e.g., actor 242) for secure booking once selections are made.

The data flow for the FDI subsystem components is now described. A pipeline for input data uses the administrative portal and the associated APIs to fetch one or more survey questions and obtain survey results. Surveys enable the system to provide dynamic filtering to provide personalized results. While surveying (using pre-defined or configured survey questions) is desirable, it is not required. Price cache data synchronization (sync) is carried out by updating the cache periodically (e.g., daily) by processing data through the price cache blob, and then using the Redis in-memory cache for efficient and fast retrieval (e.g., of cached travel package data). A processing layer processes user inputs to match survey results (when surveys are used) with cached package data and available travel options. In particular, the processing combines package-related data with origin-destination mappings for enhanced recommendations. For user interactions, users interact with the FDI site to search for packages using survey-based search (experience-oriented options) or origin-destination search. In both approaches, price cache data is fetched dynamically to display real-time travel options. Given the displayed options, users make decisions, typically by selecting a hotel (or some other component of a travel package. Users finalize their bookings via one or more booking pages of the selected component(s) (e.g., selected hotels). To this end, and as necessary, the system supports redirections to external forms that provide for secure and streamlined purchase completion. Without intending to be limiting, the FDI subsystem may leverage AngularJS for end user-facing interfaces (user-facing branded websites), SQL Server for structured data storage, the Redis-based distributed cache for high-performance data retrieval, and Microsoft . NET-based APIs.

The above-described FDI architecture provides a robust and scalable frontend system for personalized travel information search and retrieval. It integrates real-time package data caching, user-centric workflows, and survey-based search capabilities that together ensure an intuitive and seamless booking experience.

The following provides additional details regarding the price cache and its associated API in a particular embodiment. In this embodiment, raw data (e.g., OnSale™ or other real-time or historical online travel agency data) provides a list of package details, such as origin, destination, data, price, theme, hotel data, and the like. Using the price cache API, the system the consumes data from one or more endpoints. Typically, the data comprises origins, destinations with origin, choices, and packages, wherein the package data typically includes a package that is defined by its origin code, and an associated destination code. Via the APIs the price cache synchronization runs periodic synchronization jobs to fetch the data to the system database (e.g., MongoDB). Typically, the data is refreshed for every day at the start of a local time period. For example, every day at a given time, data from RateGain and Sabre is fetched and curated into a large number (typically millions) of travel packages. To enable this large data set to be manipulated efficiently in-memory, it is first reduced in size using a special key, namely “inventory_origin_number of nights.” By using this format, a large data set (on the order of 180 MB) is significant reduced in size (to less than 1 MB) for consumption by the FDI. More specifically, and by curating the data using this format, the large number of (typically origin and destination) combinations is sufficiently reduced to ensure a particular search is carried out with very low latency even as the number of concurrent transactions increases. In an illustrative embodiment, this data fetching and reduction process is executed in Azure Data Factory, which pushes the data into a SQL database in the predefined format defined by this key. As previously described, users interact with the system through the frontend interface (preferably ReactJS-based), which communicates with a .NET API. The API first checks user prompts for sensitive information, e.g., using AI language models. If no sensitive information is detected, the prompt is sent to an AI model, such as OpenAI. Based on the prompt, a predefined function is triggered to fetch and display relevant travel packages to the user.

Typically, and in use, there are multiple ways in which FDI exposes and displays relevant package details to the end user: a preferential search, a destination-less search, a map-based search, a calendar search, and combinations thereof. Further, and in part because the price data cache preferably stores pricing availability data for every day for every origin-destination pair, a search need not require any particular date (for departure or return) to be specified by the user, thus providing a date-agnostic search capability. Thus, for example, a date-agnostic, destination-less search may simply identify an origin, a broad or general time period (e.g., in March, April or May), together with a number of nights, and wherein the query seeks the “lowest price” of any travel package meeting this criteria. In response to such search query, the system returns a response from which the user can select from, drill-down for additional options, and the like. This response is delivered with very low latency and with high availability and reliability across large numbers of concurrent information search and retrieval transactions (from large numbers of concurrent users accessing the platform from multiple websites or apps), and these technical benefits are facilitated by having the very large data set first normalized using the special key and storage format as described above.

More specifically, typically preferential search is survey-based, and it is curated by user preferences/selection. Destination-less search is a destination-unknown search based on the origin selected by the user. When this search is selected, the system auto-fills a nearest origin airport from an origin list, preferably based on a user IP address. Once the user selects the origin, all destinations based on the origin are then fetched from the in-memory data in the cache, and wherein fast retrieval is facilitated by the in-memory data having been reduced in size using the above-described key. Map-based search works in a similar manner with results displayed on a map. Search results then display a list of curated packages. Preferably, curated data rendered on a results page conform to one or more recommendation criteria, such as data based on a lowest fare with a highest hotel rating for a given number (e.g., 3) nights of data, with the 3 nights being defined by today+1 and today+3 or a nearest available package, and wherein an order of the packages are defined by a priority value of a property of each package.

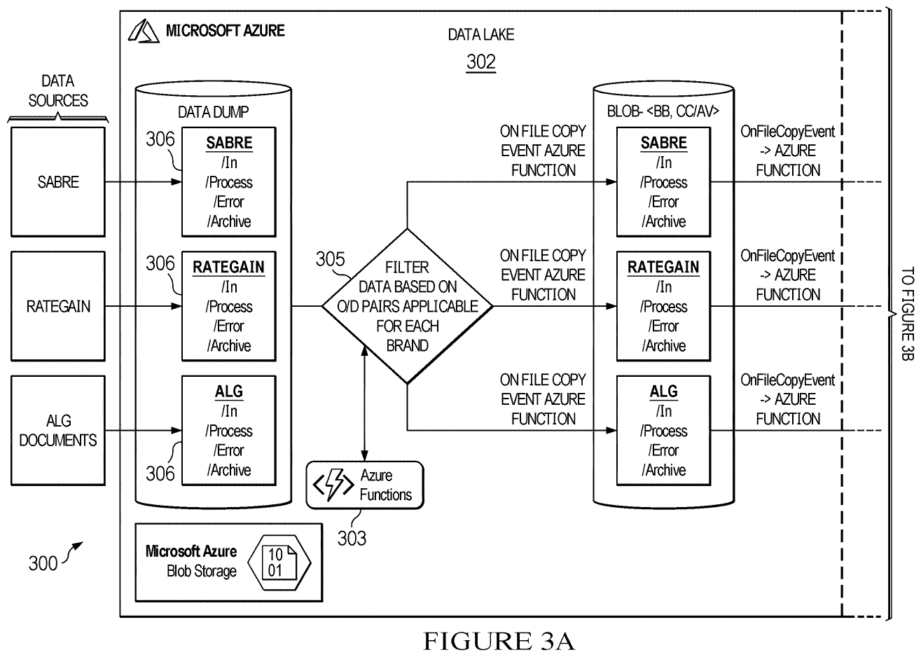

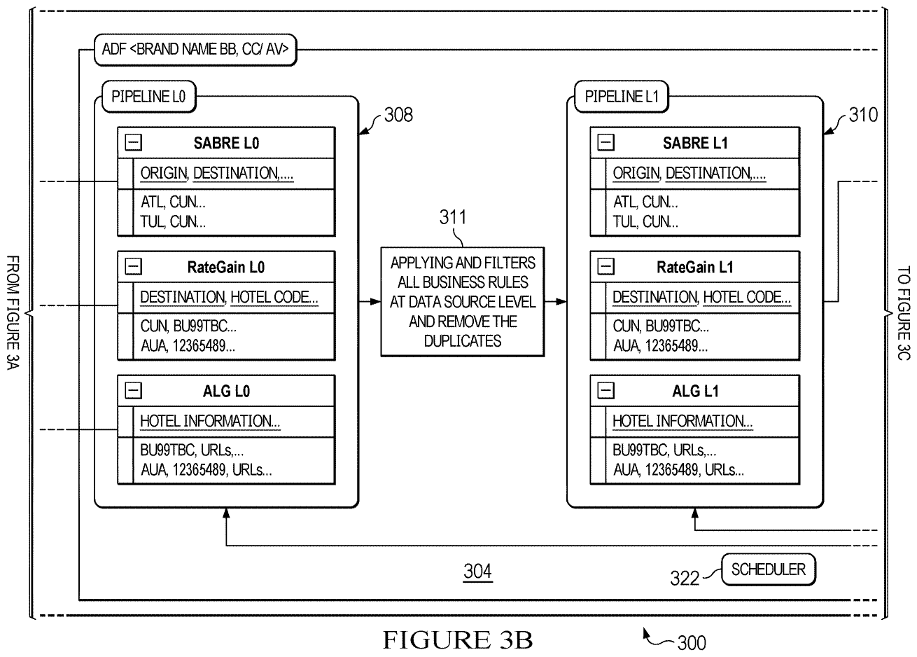

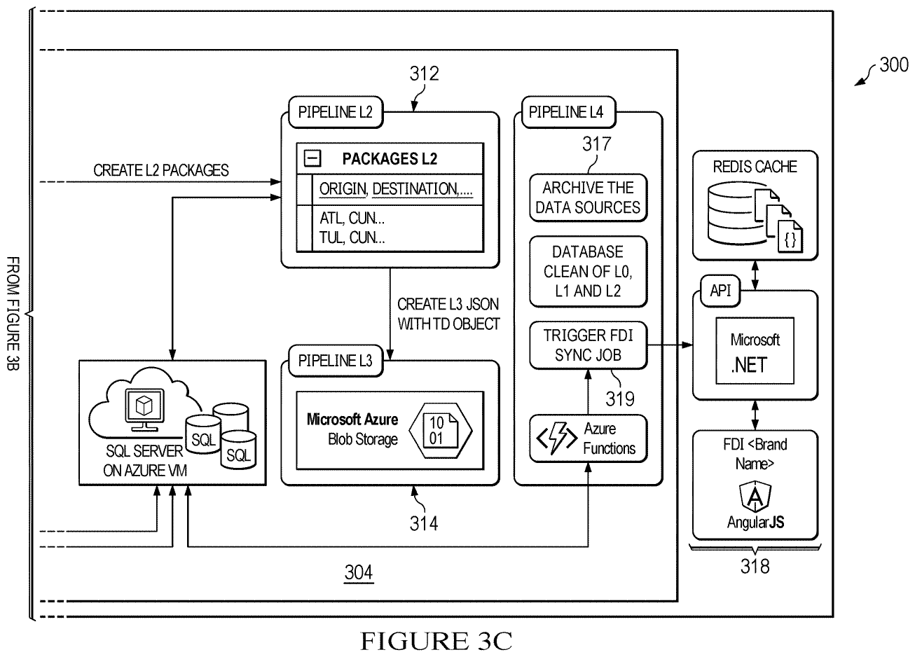

FIGS. 3A-3C together depict additional details of the price cache architecture. As will be described, the caching architecture automates the process of extracting, loading and transforming the very large amount of disparate data fetched into the system to being carried out within a very short time period (e.g., less than 2 hours) such that the system updates daily. Preferably, data is extracted in raw format and filtered to eliminate duplicate records. The final formatted data is preferably stored in a data zone, and travel packages are then generated for different compositions. As depicted, the price cache architecture 300 comprises a data lake 302, and set of processing pipelines 304 for data transformation, storage, and integration with downstream applications, such as FDI end user-facing websites. The architecture ensures efficient data handling, transformation, and integration with the applications. After processing, the system generates the very large number (typically millions) of travel packages and provides this data for efficient retrieval by the multiple websites or web apps serviced by the platform and its price cache.

In a preferred embodiment, data is ingested into a data store (such as Azure blob storage), which acts as a primary data lake storage 302 for raw data ingestion. The data store organizes incoming data into one or more directories 306 for each data source.

One or more processing functions 303 (implemented as Azure functions) trigger the processing of new files, e.g., monitoring the data lake for new file uploads, initiating processing for each source-specific file, archiving successfully-processed files and, as necessary, moving failed files to an error directory. This processing takes place in the processing pipelines 304. In particular, preferably multi-layer pipelines transform the raw data into clean, aggregated datasets. In this embodiment, these pipelines are implemented as Azure Data Factory pipelines. A first pipeline (Pipeline LO) 308 processes raw data files from the data lake, extracts key information (such as SABRE: origin, destination, and flight information; RATEGAIN: destination, hotel code, and hotel information; ALG: hotel information and business rules). The raw data from these sources is ingested into the system through the Azure data lake 302 for further processing. A second pipeline (Pipeline L1) 310 applies business rules and data filters 311 at the source level, removes duplicate records, and produces clean data for the next layer. A third pipeline (Pipeline L2) 312 aggregates data into packages, e.g., based on (i) airline data of origin, destination, and others, and (ii) hotel data of destinations, and other hotel details. This pipeline also creates Level 2 (L2) (in this example RATEGAIN and SABRE) data sets and Level 3 (L3) (packages) for further analysis. A fourth pipeline (L3) 314 generates JavaScript Object Notation (JSON) outputs that are stored for downstream use. JSON files include origin and night-based data, detailing all destination hotel information. Each hotel record preferably includes data for up to a given number of days. This pipeline saves the JSON objects back to the data store. A fifth pipeline (L4) 316 archives the processed data sources 317, and, at step 319, it triggers an FDI synchronization (sync) job to sync the processed data to downstream applications as previously described in FIGS. 1 and 2. In particular, the processed data is synced to be consumed by one or more FDI end user-facing sites or apps 318, which display interfaces for travel packages and booking details. These operations are carried out by a scheduler 320, which orchestrates the execution of the pipelines for the data sources, and it ensures timely processing and availability of data for downstream systems. A set of business rules 322 provide additional data to facilitate package customization, such as hotel priority rankings for better improved recommendations, and score rankings for hotel amenities and services. The websites or apps 318 are typically implemented as web applications (e.g., powered by AngularJS); these application integrate the processed data through APIs, and display interfaces for travel packages and booking details.

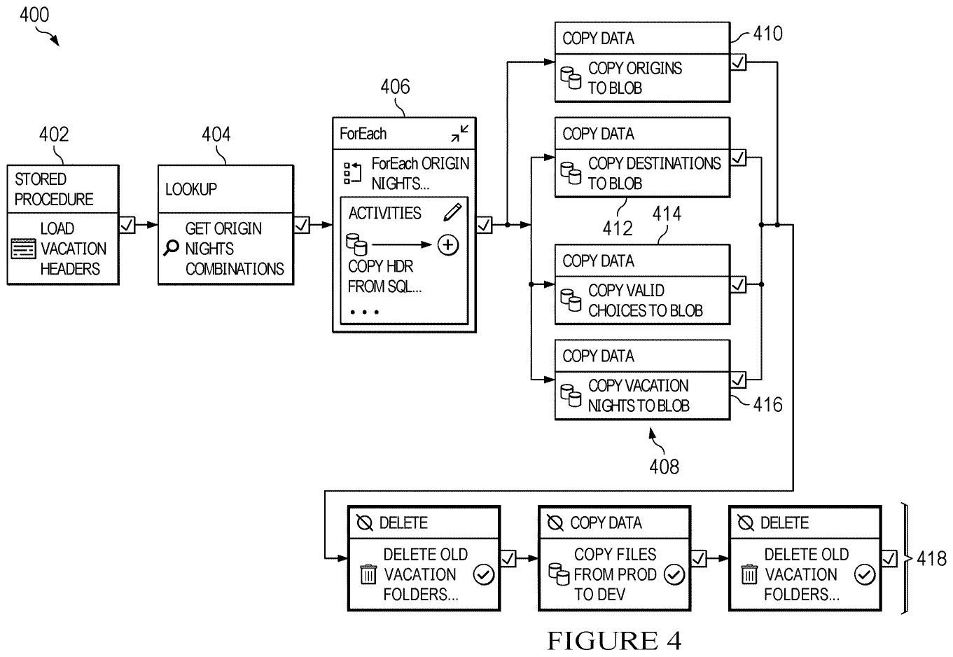

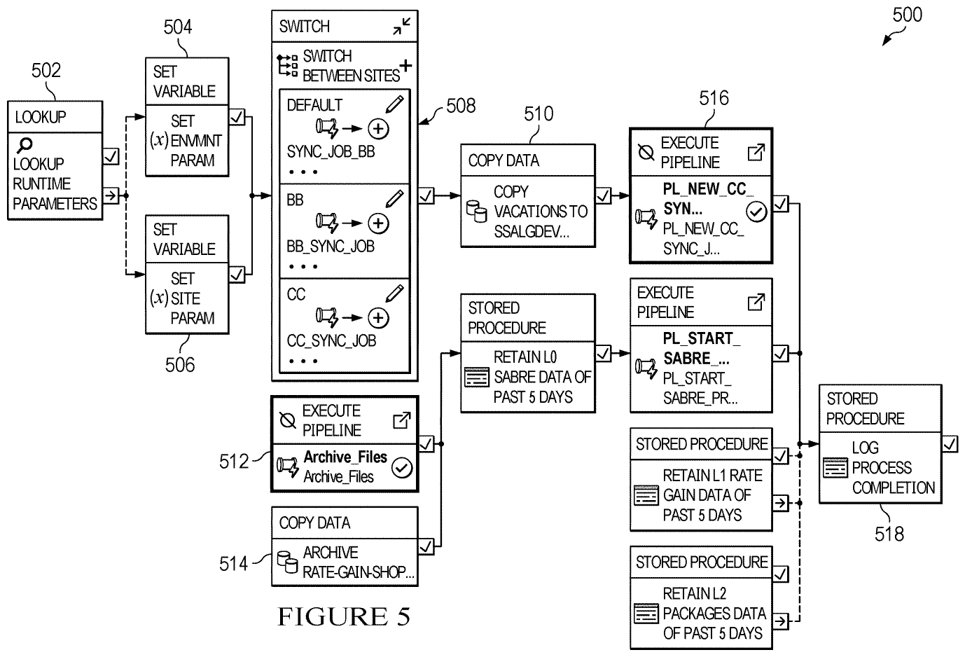

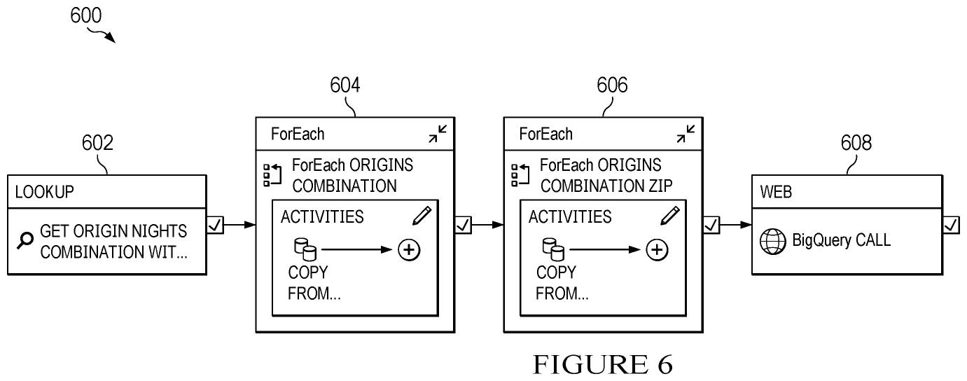

The following provides additional details regarding the operation of particular data processing pipelines in the preferred embodiment. These includes a write_vacations_to_blob pipeline 400 such as depicted in FIG. 4, a conclusion_activities pipeline 500 as depicted in FIG. 5, and a query_push_activity pipeline 600 as depicted in FIG. 6.

These pipelines assume that the following data sources are processed and loaded: RateGain data, Sabre data, ALGV data, L2 and L3 data, and destinations (cities). Referring to FIG. 4, the write_vacations_to_blob pipeline 400 processes vacation data in multiple steps, first loading header data and combinations, then performing parallel data extraction and transformation for different origin/nights combinations, and finally copying results to the data lake (Azure blob storage). To this end, the pipeline begins with a Stored Procedure Activity 402 that loads or prepares header records needed for vacation data processing. This process also initializes or clears a main data set for the processing run. Next, a Lookup Activity 404 retrieves a list of combinations of origin locations and the number of nights (e.g., city/data pairs), and prepares the list so that the rest of the pipeline can iterate over each combination. Thereafter, a forEach Activity 406 a set of defined activities for each origin/nights combination found in the previous lookup. These defined activities are run in parallel (or optionally in sequence, depending on configuration). The activities include pulling/processing data for each origin/nights pair, and executing scripts or additional processing needed for each pair. Next, a set of one or more Copy Data Activities 408 are carried out. These include, for example, Copy Origins To Blob 410, which extracts and writes the origins data to blob storage for further use/archiving, Copy Destinations To Blob 412, which extracts and writes the destinations data to blob storage for further use/archiving, Copy Valid Choices To Blob 414, which extracts and writes validated or final approved choices to blob storage for further use/archiving, and Copy Vacation Nights To Blob 416, which extracts and writes processed vacation nights data to blob storage for further use/archiving. Preferably, each Copy Data activity performs an ETL (Extract-Transform-Load) operation, moving structured results from SQL (or other source) into Azure Blob as files for persistent storage or later consumption. A set of clean-up functions 418 are then run to complete the pipeline execution.

FIG. 5 depicts the conclusions_activities pipeline 500, which orchestrates vacation and Sabre data processing, including dynamic site selection, parameter handling, data synchronization, archival, and cleanup. It uses lookups, variable setting, branching (switch), data copying, pipeline execution, and stored procedures to accomplish this workflow. The following describe an Activity-by-Activity breakdown of the pipeline. At 502, a Lookup Activity retrieves runtime parameters from the SQL database, and these parameters are used to set environment and site-specific settings for downstream logic. A first Set Variable Activity 504 assigns a runtime environment parameter (extracted from lookup) to a pipeline variable; this parameter is used for environment-specific branching or configuration. A second Set Variable Activity 506 sets a site identifier/parameter from the runtime lookup. The pipeline then continues with a Switch Activity 508, which provides a logic branch to determine site-specific procedures and flows. In particular, this operation determines which site's data sync and processing logic to follow based on parameters. A Copy Data Activity 510 transfers vacation data from the source system (e.g., Azure SQL database or other relational store), loads data directly into a blob storage container, extracts vacation records based on defined criteria, applies necessary data transformations during the transfer (if required), stores results in a designated blob storage location for ongoing access, makes vacation data available for downstream processing, analytics, and archiving, and enables integration with other systems and data flows. An Execute Pipeline Activity 512 initiates another sub-pipeline focused on SABRE data processing for the selected site. Another Copy Data Activity 514 archives legacy or processed RATE GAIN/shop-related data into the data store. An Execute Pipeline Activity 516 executes an archival sub-pipeline that provides for archiving day-to-day or batch files. One or more Stored Procedures Activities 518 are then carried out to store datasets according to various rules or configurations, and then log completion of all processing and retention activities for auditing, monitoring, or operational visibility.

FIG. 6 depicts a query_push_activity pipeline 600 of the price cache. At 602, a Lookup Activity retrieves distinct origin-nights combinations and dynamically generates file paths for JSON and ZIP files. A ForEach Origins Combination loop 604 performs a Copy Data activity for each combination, reading from a source JSON file and writing to a corresponding output path. A ForEach Origins Combination ZIP loop 606 runs a Copy Data activity to compress JSON files for each origin into ZIP files and stores them in a specified output location. This processed data is then used to fulfill a call from the web application 608.

The above-described system provides significant advantages. It provides a user centric experience (via the AI shopping assistant) wherein a user can interact with a virtual travel assistant via AI-based chat. The data processing pipelines ensure prompt retrieval and display of accurate responses from the curated database for flights, hotels, packages and prices, based on user preference-based search, destination-less search or map-based search.

Generalizing, the cloud service is a technology platform that may comprise co-located hardware and software resources, or resources that are physically, logically, virtually and/or geographically distinct. Communication networks used to communicate to and from the platform services may be packet-based, non-packet based, and secure or non-secure, or some combination thereof. More generally, the cloud service comprises a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines.

Typically cloud-based services are delivered through virtual machines (VMs) or containers. A virtual machine is a complete guest host running inside of a host system. When virtual machines are used, applications are installed, packaged, and run under the control of a hypervisor, which virtualizes the hardware environment. Containers, in contrast, provide an operating environment wherein only the essential parts of the application (sometimes referred to as cloud services) and its dependencies are included, and there can be multiple containers running within a single instance of an operating system, such as Linux. Docker is a virtualization platform that shares a single Linux kernel with all running instances (called containers). Other container-based technologies include, among others, Kubernetes, and OpenShift. Generalizing, a container typically is a single software unit packaged with all of its dependencies into an image designed to run reliably on diverse systems. Container resources are managed via process control groups and isolated via kernel namespaces. A container orchestration engine decides where containers will run in a managed cluster, as well as creates a private network for communication.

As noted above, a low latency, high-throughput distributed transaction processing system (TPS) may be implemented in one or more cloud environments, such as Microsoft® Azure®, Google® Cloud Platform (GCP), and Amazon AWS. These operating environments are not intended to be limited. In addition, the system may interoperate with a Global Distribution System (GDS), a Billing and Settlement Plan (BSP), and other such mechanisms that have been developed in the online travel industry. A Global Distribution System (GDS) is a computerized network system owned or operated by a company that enables transactions among travel industry service providers, mainly airlines, hotels, car rental companies, and travel agencies. Typically, a GDS uses real-time inventory (e.g. number of hotel rooms available, number of flight seats available, or number of cars available) from the service providers. Travel agencies traditionally relied on GDS for services, products and rates in order to provide travel-related services to the end consumers. Thus, traditionally a GDS links services, rates and bookings consolidating products and services across all three travel sectors: i.e., airline reservations, hotel reservations, car rentals. GDS is different from a computer reservation system, which is a reservation system used by the service providers (also known as vendors). The primary customers of GDS are travel agents (both online and office-based), who make reservations on various reservation systems run by the vendors. GDS holds no inventory; the inventory is held on the vendor's reservation system itself, and a GDS system typically has a real-time link to the vendor's database. For example, when a travel agency requests a reservation on the service of a particular airline company, the GDS system routes the request to the appropriate airline's computer reservations system. A BSP is an electronic billing system designed to facilitate the flow of data and funds between travel agencies and airlines. The advantage of such an intermediary organization is that instead of each travel agency having an individual relationship with each airline, all of the information is consolidated through the BSP. Typically, BSP's are organized on a local basis, usually one per country. There are BSP operations worldwide, and they provide services for the settlement of financial transactions between travel agents and airlines. Tickets sold via travel agencies outside of the United States are processed by the BSP of the International Air Transport Association (IATA), a trade association for the world's airlines, and through its BSPlink internet-based system. Settlements for tickets sold via agencies within the United States typically are processed by ARC, operated by the Airline Reporting Corporation. There are several other legacy settlement systems. BSP and ARC facilitate these interactions and exchanges of information and settlements between and among all participants.

There is no limitation on the type of computing entity that may implement the client-side or server-side of any communication. Any computing entity (system, machine, device, program, process, utility, or the like) may act as the client or the server.

The platform functionality may be co-located or various parts/components may be separately and run as distinct functions, perhaps in one or more locations (over a distributed network). The functionality may be implemented with other application layer protocols besides HTTP/HTTPS, or any other protocol having similar operating characteristics.

The LLM or “language model” portion of the above-described solution may vary, and, as noted, it may itself be accessible directly, or indirectly (via API or otherwise). Formally, the “language model” is a probabilistic model of sequences. In the case of natural language, language models typically describe the probability of sentences or documents. Being simply probabilistic models, language models can take on many specific incarnations, e.g., from column frequencies in multiple sequence alignments to Hidden Markov Models to deep neural networks.

What is claimed follows below.

1. An information search and retrieval method, comprising:
receiving raw data from a set of data sources, each data source providing one or more data elements;
processing the raw data from the set of data sources into a plurality of aggregated datasets, wherein a dataset of the plurality of aggregated datasets includes data elements from two or more of the data sources, and wherein processing the raw data from the set of data sources utilizes a data element key-based data transformation;
based at least in part on the data element key-based based transformation, organizing the plurality of aggregated datasets for efficient data querying and retrieval;
during an Artificial Intelligence (AI)-assisted workflow;
receiving and verifying a query, the query specifying a given data element as a search criteria;
responsive to verification of the query, and based on the search criteria, retrieving for display a subset of the plurality of aggregated datasets;
displaying the subset of the plurality of aggregated datasets; and
responsive to receipt of a selection, implementing an automated transaction workflow to finalize a transaction defined by the search criteria and a given one of the plurality of aggregated datasets as determined by the selection.

2. The information search and retrieval method as described in claim 1, wherein organizing the plurality of aggregated datasets includes structuring one or more semantic views in a distributed in-memory cache.

3. The information search and retrieval method as described in claim 1, wherein verifying the query includes determining whether the query includes sensitive information associated with a requesting user, and selectively removing the sensitive information.

4. The information search and retrieval method as described in claim 1, further including receiving an AI-generated response, the AI-generated response including information identifying the subset of the plurality of aggregated datasets.

5. The information search and retrieval method as described in claim 1, wherein the set of data sources comprise travel package-related data.

6. The information search and retrieval method as described in claim 5, wherein the given data element is an origin for a travel package.

7. The information search and retrieval method as described in claim 6, wherein the origin for the travel package is the only search criteria.

8. The information search and retrieval method as described in claim 7 wherein the automated transaction workflow is a booking of a travel package that includes the origin and a destination associated to the origin.

9. The information search and retrieval method as described in claim 1, wherein the receiving, processing and organizing operations are carried out periodically.

10. The information search and retrieval method as described in claim 1, wherein the data element key-based based transformation uses a data key that consists of: an inventory data element, an origin data element, and a number of nights data element.

11. The information search and retrieval method as described in claim 1, wherein the AI-assisted workflow leverages one or more AI models.

12. The information search and retrieval method as described in claim 11, wherein the one or more AI models include a large language model (LLM).

13. The information search and retrieval method as described in claim 1, operated as software-as-a-service.

14. The information search and retrieval method as described in claim 1, wherein the plurality of aggregated datasets comprise curated travel packages.

15. The information search and retrieval method as described in claim 1, wherein the AI-assisted workflow uses one or more preconfigured prompt templates.

16. The information search and retrieval method as described in claim 1, wherein the AI-assisted workflow is carried out concurrently from each of a plurality of end users.

17. An information search and retrieval system, comprising:
one or more hardware processor; and
computing memory holding computer program instructions executed by the one or more hardware processors, the computer program instructions configured to perform information search and retrieval by:
receiving raw data from a set of data sources, each data source providing one or more data elements;
processing the raw data from the set of data sources into a plurality of aggregated datasets, wherein a dataset of the plurality of aggregated datasets includes data elements from two or more of the data sources, and wherein processing the raw data from the set of data sources utilizes a data element key-based data transformation;
based at least in part on the data element key-based based transformation, organizing the plurality of aggregated datasets for efficient data querying and retrieval;
during an Artificial Intelligence (AI)-assisted workflow;
receiving and verifying a query, the query specifying a given data element as a search criteria;
responsive to verification of the query, and based on the search criteria, retrieving for display a subset of the plurality of aggregated datasets;
displaying the subset of the plurality of aggregated datasets; and
responsive to receipt of a selection, implementing an automated transaction workflow to finalize a transaction defined by the search criteria and a given one of the plurality of aggregated datasets as determined by the selection.

18. A computer program product in a non-transitory computer-readable medium comprising computer program code executable in one or more hardware processors, the computer program code configured for information search and retrieval by:
receiving raw data from a set of data sources, each data source providing one or more data elements;
processing the raw data from the set of data sources into a plurality of aggregated datasets, wherein a dataset of the plurality of aggregated datasets includes data elements from two or more of the data sources, and wherein processing the raw data from the set of data sources utilizes a data element key-based data transformation;
based at least in part on the data element key-based based transformation, organizing the plurality of aggregated datasets for efficient data querying and retrieval;
during an Artificial Intelligence (AI)-assisted workflow;
receiving and verifying a query, the query specifying a given data element as a search criteria;
responsive to verification of the query, and based on the search criteria, retrieving for display a subset of the plurality of aggregated datasets;
displaying the subset of the plurality of aggregated datasets; and
responsive to receipt of a selection, implementing an automated transaction workflow to finalize a transaction defined by the search criteria and a given one of the plurality of aggregated datasets as determined by the selection.
